(19) United States
(12) Patent Application Publication
(10) Pub. No.: US 2025/0076499 A1
(43) Pub. Date: Mar. 6, 2025

(54) ULTRASONIC OBJECT DETECTION

(71) Applicant: GM Cruise Holdings LLC, San Francisco, CA (US)

(72) Inventors: Yingchang Yang, Palo Alto, CA (US); Amanda Lind, Brooklyn, NY (US); Behrad Kajbafzadeh, Redwood City, CA (US); Jason Seitz, Oakland, CA (US); Anurup Guha, Sunnyvale, CA (US); Nicholas Robinson, San Francisco, CA (US); Fred Schleifer, San Francisco, CA (US); Daniel Zaenker, San Francisco, CA (US)

(73) Assignee: GM Cruise Holdings LLC, San Francisco, CA (US)

(21) Appl. No.: 18/457,848

(22) Filed: Aug. 29, 2023

(51) Int. Cl. G01S 15/931; G01S 7/52; G01S 15/10

(52) U.S. Cl. CPC G01S 15/931; G01S 7/52077; G01S 15/104; G01S 2015/938

(57) ABSTRACT

An ultrasonic detection system provides enhanced object detection capabilities. The ultrasonic detection system can generate complex ultrasonic waveforms based on excitation voltage waveforms constructed using high frequency components. In certain embodiments, an ultrasonic detection system may be capable of producing multiple different waveforms, e.g., different waveforms output by different transmitters, or multiple time-multiplexed waveforms output by the same transmitter. The ultrasonic detection system may be included in an autonomous vehicle (AV) for object detection in the environment of the AV.

### TECHNICAL FIELD OF THE DISCLOSURE

The present disclosure relates generally to object detection and, more specifically, to object detection using ultrasonic waves and systems for producing ultrasonic wave patterns.

### BACKGROUND

Ultrasonic sensors are used for various applications, such as medical imaging, factories and processing plants, and automotive range detecting. Ultrasound systems typically include an ultrasonic transducer to generate an ultrasonic sound wave and capture a reflection of the sound wave. By analyzing the echo reflected from an object, a distance to the object can be estimated. The accuracy of the estimation depends on multiple factors, such as the frequency and magnitude of the ultrasound signal. Previous sensors for ultrasound distance ranging include a switching circuit that operates at the frequency of the ultrasound wave to generate the excitation waveform. This does not allow the sensors to generate different waveforms, or to generate waveforms having complex shapes. While the outputs are often adequate for relatively simple tasks, such as ranging to a nearby car when parallel parking, current ultrasound sensors are not able to perform more complex object detection or recognition tasks.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system including a fleet of vehicles used for an autonomous driving service according to some embodiments of the present disclosure;

FIG. 2 is a block diagram of a sensor suite of a vehicle, according to some embodiments of the present disclosure;

FIG. 3 is a block diagram of an ultrasound system, according to some embodiments of the present disclosure;

FIGS. 4A and 4B are side and top views of a vehicle that includes multiple ultrasound systems, according to some embodiments of the present disclosure;

FIG. 5 is a block diagram illustrating an example ultrasound system generating a wave and receiving a reflection, according to some embodiments of the present disclosure;

FIG. 6 is a block diagram illustrating an example ultrasound system generating a pair of time multiplexed waves and receiving their reflections, according to some embodiments of the present disclosure;

FIG. 7 is a block diagram illustrating an example ultrasound system generating two different waveforms and receiving their reflections simultaneously, according to some embodiments of the present disclosure;

FIG. 8 is a block diagram illustrating an example ultrasound system generating two time multiplexed waves of the same frequency and another separate wave with a different frequency and receiving their reflections, according to some embodiments of the present disclosure; and

FIG. 9 is a flowchart illustrating a method for object detection using an ultrasonic system, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

The ultrasonic detection systems described herein provide enhanced object detection capabilities compared to previous ultrasound systems. For example, the ultrasonic detection systems can generate complex ultrasonic waveforms based on excitation voltage waveforms constructed using high frequency components. In certain embodiments, an ultrasonic detection system may be capable of producing multiple different waveforms, e.g., different waveforms output by different transmitters, or multiple time-multiplexed waveforms output by the same transmitter.

In some embodiments, an ultrasound system includes a transmit channel that couples a controller to one or more transmitters or transducers. The controller provides instructions to the transmit channel to generate a waveform. The transmit channel generates an excitation voltage waveform based on the instructions. The transmit channel may include a receiving component to receive the instructions and a processing component that constructs an electrical signal based on the received instructions. The processing component may have a frequency that is greater than the frequency of the desired ultrasonic waveform, e.g., at least ten times or 100 times the frequency. Including a high-frequency processing component enables the processing component to generate complex waveforms and/or a variety of different waveforms, such as waveforms having different frequencies (e.g., a wave at 50 kilohertz (kHz) followed by a wave at 51 kHz). The signal output by the processing component may travel through several signal processing components in the transmit channel, such as a power amplifier, analog filter, and/or transformer. The output of the transmit channel is a voltage signal that is converted into an ultrasonic wave by a transmitter.

The ultrasonic wave is reflected by one or more objects in the environment of the transmitter. The ultrasound system further includes one or more receivers to detect these reflections of the ultrasonic wave. The reflected signals are provided to the controller, which may process the reflected signals to determine information about the environment of the ultrasound system, e.g., a distance to an object in the environment, a speed of the object, a size of the object, etc. Using multiple frequencies and one or more multiplexing schemes can provide more detailed information about the object. In addition, including multiple transmitters (and, in some cases, associated transmit channels) and/or multiple receivers in the ultrasound system can enhance detection capabilities. Various system arrangements are described in detail below.

One or more of the ultrasonic detection systems described herein may be included in a vehicle, such as an autonomous vehicle (AV). For example, an AV may include several ultrasound systems in various locations around the AV to collect data describing objects at various positions in the environment of the AV, such as nearby cars, pedestrians, bikes, buses, buildings, etc. The ultrasound systems may be used in conjunction with additional sensor systems, such as cameras, light detection and ranging (lidar) sensor(s), and/or radar sensor(s) to obtain information about the AV's environment.

As will be appreciated by one skilled in the art, aspects of the present disclosure, in particular aspects of ultrasonic detection systems, ultrasonic detection methods, and vehicles configured for ultrasonic detection, as described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Fleet

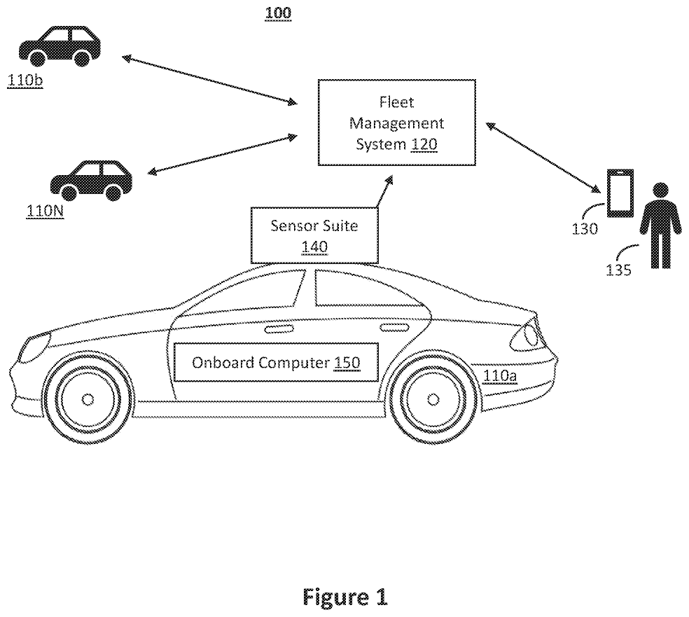

FIG. 1 is a block diagram illustrating a system including a fleet of AVs used for an autonomous driving service according to some embodiments of the present disclosure. The system 100 includes a fleet of AVs 110, including AV 110a, AV 110b, and AV 110N, a fleet management system 120, and a user device 130. For example, a fleet of AVs may include a number N of AVs, e.g., AV 110a through AV 110N. AV 110a includes a sensor suite 140 and an onboard computer 150. The sensor suite 140 may include one or more ultrasonic detection systems, as described herein. AVs 110b through 110N also include the sensor suite 140 and the onboard computer 150. A single AV in the fleet is referred to herein as AV 110, and the fleet of AVs is referred to collectively as AVs 110.

The fleet management system 120 receives service requests for the AVs from user devices, such as user device 130. For example, the user 135 accesses an app executing on the user device 130 and, using the app, enters a ride request. The user device 130 transmits the ride request to the fleet management system 120. The ride request includes at least a pickup location (e.g., the current location of the user device 130) and may further include a drop-off location, a number of passengers, a pickup and/or drop-off time, or other information. The fleet management system 120 selects an AV from the fleet (e.g., AV 110a) and dispatches the selected AV to the pickup location to carry out the ride request.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc. Additional external devices of the AV 110, including speakers and a spray system, are described in relation to FIG. 3.

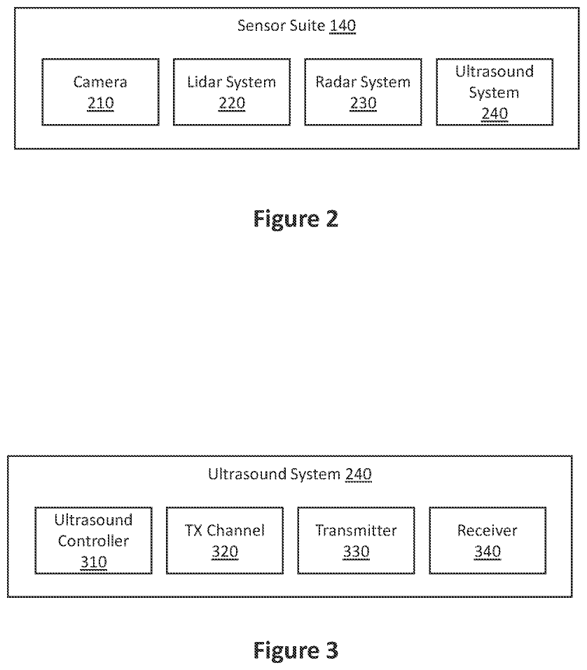

The AV 110 includes a sensor suite 140, which includes a computer vision (“CV”) system, localization sensors, and driving sensors. For example, the sensor suite 140 may include interior and exterior cameras, radar sensors, sonar sensors, lidar (light detection and ranging) sensors, thermal sensors, GPS, wheel speed sensors, inertial measurement units (IMUs), accelerometers, microphones, strain gauges, pressure monitors, barometers, thermometers, altimeters, ambient light sensors, etc. In embodiments described herein, the sensor suite 140 may include one or more ultrasonic detection systems, such as the ultrasound systems described with respect to FIGS. 2-9. The sensors may be located in various positions in and around the AV 110. For example, the AV 110 may have multiple ultrasound transceivers located at different positions around the exterior and/or interior of the AV 110. Particular components of the sensor suite 140 are described in greater detail in relation to FIG. 2.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls the behavior of the AV 110. The onboard computer 150 may be a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

The fleet management system 120 manages the fleet of AVs 110. The fleet management system 120 may manage one or more services that provides or uses the AVs, e.g., a service for providing rides to users using the AVs. The fleet management system 120 also manages fleet maintenance tasks, such as fueling, inspecting, and servicing of the AVs. The AVs 110 and the fleet management system 120 may connect over a public network, such as the Internet.

The user device 130 is a personal device of the user 135, e.g., a smartphone, tablet, computer, or other device for interfacing with a user of the fleet management system 120. The user device 130 and the fleet management system 120 may connect over a public network, such as the Internet. The user device 130 may provide one or more applications (e.g., mobile device apps or browser-based apps) with which the user 135 can interface with a service that provides or uses AVs, such as a service that provides rides to users in AVs, or a delivery service that delivers items to a location specified by a user. The service, and particularly the AVs associated with the service, is managed by the fleet management system 120, which may also provide the application to the user device 130. The application may provide a user interface to the user 135 during rides, such as a map showing the location of the AV 110 and the destination location.

### Example AV Sensor Suite

FIG. 2 is a block diagram of the sensor suite 140 of the AV 110, according to some embodiments of the present disclosure. The sensor suite 140 includes a set of environmental sensors, e.g., a camera 210, a lidar system 220, a radar system 230, and an ultrasound system 240. Different and/or additional components may be included in the sensor suite 140. For example, the sensor suite 140 may also include photodetectors, sonar, GPS, wheel speed sensors, IMUs, accelerometers, microphones, strain gauges, pressure monitors, barometers, thermometers, altimeters, etc., as described with respect to FIG. 1. Further, while one of each of the sensors 210, 220, 230, and 240 is shown in FIG. 2, the sensor suite 140 may include more than one of each of these components, e.g., to capture the environment around the AV 110 from different positions and angles, and for redundancy.

The sensor suite 140 includes multiple types of sensors, each of which has different attributes and advantages. Combining data from many multiple sensors and different sensor types allows the AV 110 to obtain a more complete view of its environment and allows the AV 110 to learn about its environment in different conditions, e.g., at different travel speeds, and in different lighting conditions.

The camera 210 captures images of the environment around the AV 110. The sensor suite 140 may include multiple cameras 210 to capture different views, e.g., a front-facing camera, a back-facing camera, and side-facing cameras. The cameras 210 may be implemented using high-resolution imagers with fixed mounting and field of view. One or more cameras 210 may capture light at different frequency ranges. For example, the sensor suite 140 may include one or more infrared cameras and/or one or more ultraviolet cameras in addition to visible light cameras.

The lidar system 220 measures distances to objects in the vicinity of the AV 110 using reflected laser light. The lidar system 220 may be a scanning lidar that provides a point-cloud of the region scanned. The lidar system 220 may have a fixed field of view or a dynamically configurable field of view.

The radar system 230 measures ranges and speeds of objects in the vicinity of the AV 110 using reflected radio waves. The radar system 230 may be implemented using a scanning radar with a fixed field of view or a dynamically configurable field of view. As described with respect to the cameras 210, the sensor suite 140 may include multiple radar systems 230 to capture different fields of view. Radar systems 230 may include articulating radar sensors, long-range radar sensors, short-range radar sensors, or some combination thereof.

The ultrasound system 240 generates ultrasound waves and captures reflections of the ultrasound waves in the vicinity of the AV 110. The ultrasound system 240 is described in detail with respect to FIGS. 3-9. As described with respect to the cameras 210, the sensor suite 140 may include multiple ultrasound systems 240 to capture different fields of view.

### Example Ultrasound System

FIG. 3 is a block diagram of the ultrasound system 240, according to some embodiments of the present disclosure. While block diagram of FIG. 3 illustrates the ultrasound system 240 in the sensor suite 140 of the AV 110, the ultrasound system 240 described herein may be used in different use cases, such as non-autonomous vehicles and non-vehicular applications.

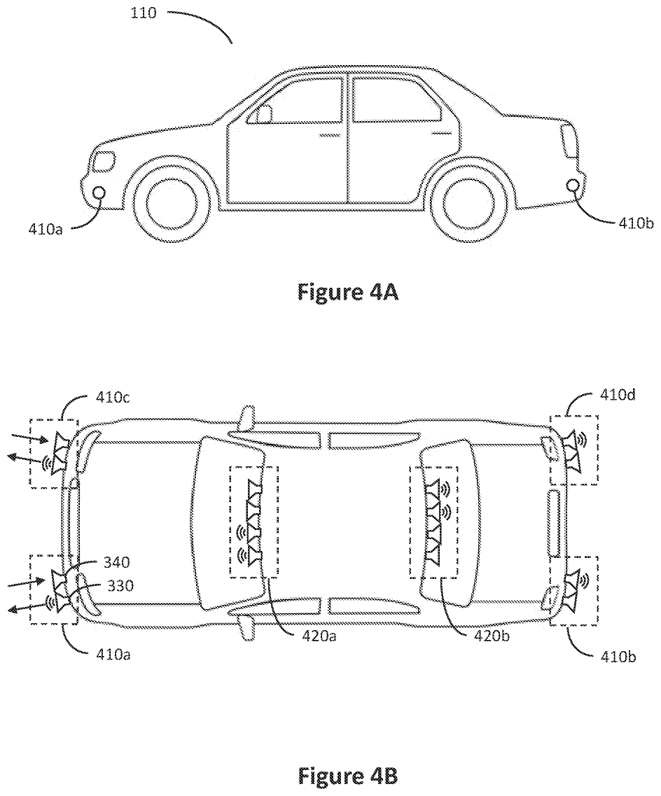

The ultrasound system 240 includes an ultrasound controller 310, a transmit (TX) channel 320, a transmitter 330, and a receiver 340. Different and/or additional components may be included in the ultrasound system 240. Further, while one of each of the components 310, 320, 330, 340 is shown in FIG. 3, the ultrasound system 240 may include more than one of one or more of these components, e.g., multiple TX channels 320 coupled to multiple transmitters 330. Example ultrasound systems with two or more TX channels 320, transmitters 330, and/or receivers 340 are illustrated in FIGS. 4 and 6-8.

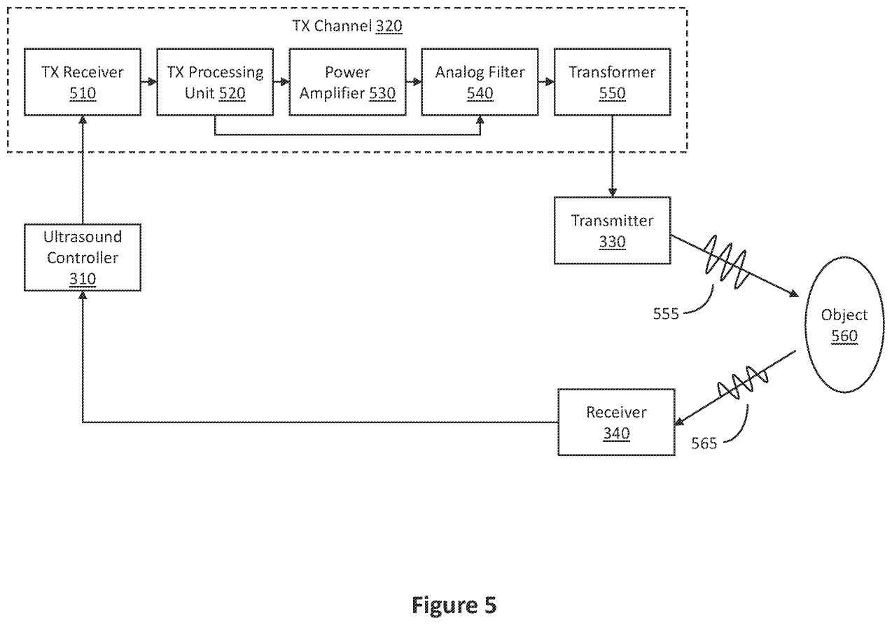

The ultrasound controller 310 controls operations of the other components 320-340. For example, the ultrasound controller 310 provides instructions for the transmitter 330 to output ultrasonic waves. For example, as illustrated in FIG. 5, the ultrasound controller 310 may be coupled to a TX channel 320, which generates an electrical waveform according to the instructions from the ultrasound controller 310, and the transmitter 330 outputs an ultrasonic wave based on the electrical waveform. The ultrasound controller 310 may further instruct the receiver 340 to detect reflected ultrasound waves and provide electrical signals encoding the reflected wave to the ultrasound controller 310. The ultrasound controller 310 may process the received electrical signal to detect objects (e.g., determine distance to an object, speed of an object, size of an object, etc.), or the ultrasound controller 310 may provide the electrical signals to another device (e.g., the onboard computer 150) to perform object detection. In some embodiments, the onboard computer 150 includes the ultrasound controller 310, e.g., the onboard computer 150 executes one or more software modules for controlling the ultrasound system 240.

The TX channel 320 receives instructions from the ultrasound controller 310 to generate an excitation voltage waveform. The TX channel 320 generates the waveform according to the instructions and provides the waveform to the transmitter 330. The instructions may include, for example, a frequency, a shape (e.g., a sine wave, a square wave, a triangle wave, a sawtooth wave, or a more complex shape), a pulse width or duty cycle, and/or other information that can be used to describe a waveform. An example TX channel 320, including components that may be included in the TX channel 320, is illustrated in FIG. 5 and described below.

The transmitter 330 receives the excitation voltage waveform from the TX channel 320. The transmitter 330 emits an ultrasonic wave according to the electrical waveform. The transmitter 330 may be specifically configured to emit ultrasonic waves, e.g., waves having frequencies higher than 20 kHz, or a specific frequency range, e.g., between 20 and 100 kHz, or between 40 and 60 kHz. In some embodiments, the transmitter 330 may also be capable of emitting sub-ultrasonic frequencies (e.g., below 20 kHz). In the AV example, the transmitter 330 is located on the AV 110 and emits sounds outside the AV 110, e.g., the transmitter 330 is directed into the environment of the AV 110. In some embodiments, the transmitter 330 is a directional transmitter that can emit sound in a particular direction selected from a larger range of directions. For example, the onboard computer 150 or ultrasound controller 310 may determine a particular direction of interest (e.g., a direction in which an object was detected using one or more of the sensor systems described with respect to FIG. 2) and instruct the transmitter 330 to emit ultrasonic waves in that direction.

The receiver 340 receives reflections of the ultrasonic waves emitted by the transmitter 330 and converts the reflected waves into electrical signals. The receiver 340 provides the electrical signals to the ultrasound controller 310 for processing, e.g., to perform object detection. A receiver 340 may be configured to detect reflected waves at a particular frequency or frequency range, e.g., at 50 kHz, or 49.5-50.5 kHz. In some embodiments, a receiver 340 may be tunable. For example, a receiver 340 may include a programmable filter to filter out signals outside of a specific frequency or frequency range. In some embodiments, the receiver 340 may have an adjustable field of view; the onboard computer 150 or ultrasound controller 310 may determine a particular direction of interest (e.g., a direction in which an object was detected using one or more of the sensor systems described with respect to FIG. 2) and instruct the receiver 340 to detect ultrasonic waves from that direction. The directionality of the transmitter 330 and receiver 340 may be controlled in tandem, e.g., both the transmitter 330 and the receiver 340 may be directed in the same direction. In some embodiments, the transmitter 330 and receiver 340 may be implemented as a single ultrasound transducer, also referred to as an ultrasound transceiver, which can both transmit and receive ultrasonic waves.

### Example Transmitter and Receiver Arrangement

FIGS. 4A and 4B are side and top views of a vehicle that includes multiple ultrasound systems, according to some embodiments of the present disclosure. FIG. 4A illustrates two example ultrasound systems 410a and 410b, which are embodiments of the ultrasound system 240 described above. The ultrasound systems 410a and 410b (referred to jointly as ultrasound systems 410) are embedded in the front and back bumpers, respectively, of the AV 110. As illustrated in FIG. 4A, the ultrasound systems 410 may be built into the bumpers and, in some embodiments, mounted flush with the bumpers, so that the ultrasound systems 410 may nearly blend in with the AV 110. In other embodiments, the ultrasound systems 410 may be more visible, e.g., the ultrasound systems 410 may protrude from the AV 110. In addition, ultrasound systems 410 may be mounted in alternate and/or additional positions in the AV 110.

FIG. 4B shows a top view of the AV 110, with schematic illustrations of several ultrasound systems (including the systems 410a and 410b), and in particular, the transmitter(s) 330 and receiver(s) 340 of each of the ultrasound systems. In the example of FIG. 4B, the ultrasound systems 410a and 410b each include one transmitter 330 and one receiver 340. The ultrasound systems 410a and 410b may further include the ultrasound controller 310 and TX channel 320 described in FIG. 3; the components 310 and 320 may be located within the bumper or elsewhere in the AV 110.

As illustrated in FIGS. 4A and 4B, the ultrasound systems 410a and 410b are near the front and back left corners of the AV 110, e.g., under the left headlight and left taillight, respectively. As shown in FIG. 4B, the AV 110 further includes ultrasound systems 410c and 410d on the opposite side of the AV 110, i.e., the right side of the AV 110. Each of the transmitters 330 and receivers 340 of the ultrasound systems 410 are arranged in a particular direction. For example, the transmit and receive directions of the transmitter 330 and receiver 340 of the ultrasound system 410a are indicated by arrows directed out of and into the transmitter 330 and receiver 340, respectively. The transmit and receive directions of the ultrasound system 410c are also illustrated in FIG. 4B. The field of views of the ultrasound systems 410a and 410c may have some overlap in a region extending from the front center of the AV 110, but the field of views of the ultrasound systems 410a and 410c are not fully overlapping, e.g., the ultrasound system 410a has a field of view that is to the left of the field of view of the ultrasound system 410c.

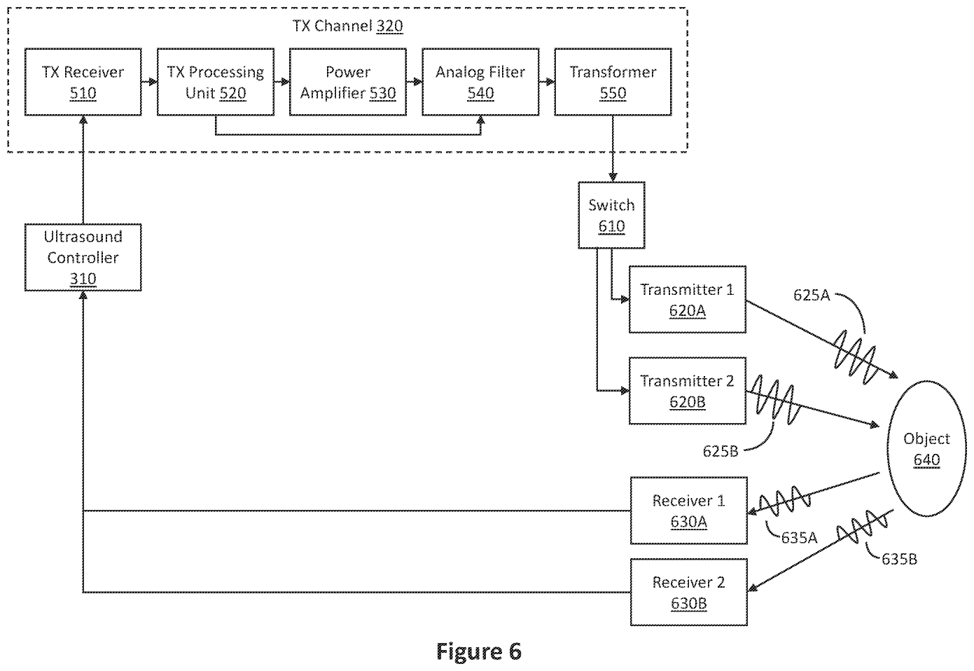

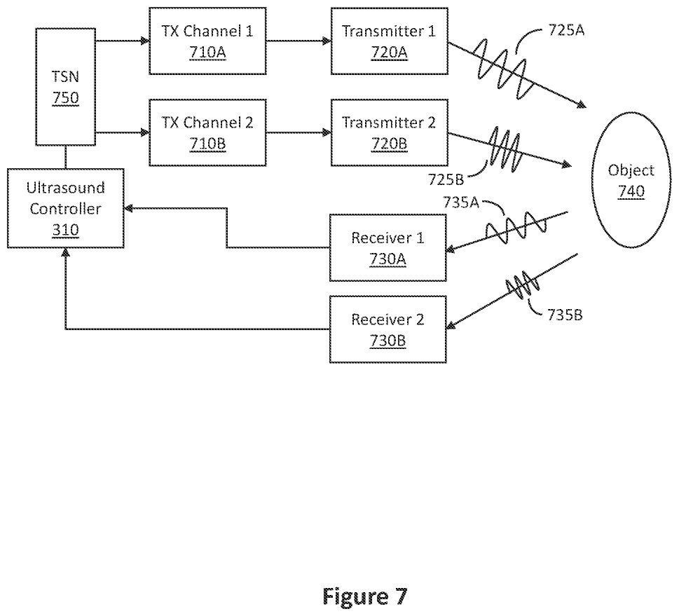

In the example of FIG. 4B, the AV 110 further includes two ultrasound systems 420a and 420b (referred to jointly as ultrasound systems 420) mounted at a top or roof of the AV 110. The ultrasound system 420a is near the front of the AV 110 and directed towards the front of the AV 110; the ultrasound system 420b is near the back of the AV 110 and directed towards the rear of the AV 110. The ultrasound systems 420 each include two transmitters 330 and two receivers 340. The ultrasound systems 420 are embodiments of the ultrasound system 240, described above. The ultrasound systems 420 may be examples of the ultrasound systems illustrated in FIG. 6 or FIG. 7. The ultrasound systems 420 may further include the ultrasound controller 310 and one or two TX channels 320 described in FIG. 3; the components 310 and 320 may be located within or under the roof of the AV 110 or elsewhere in the AV 110.

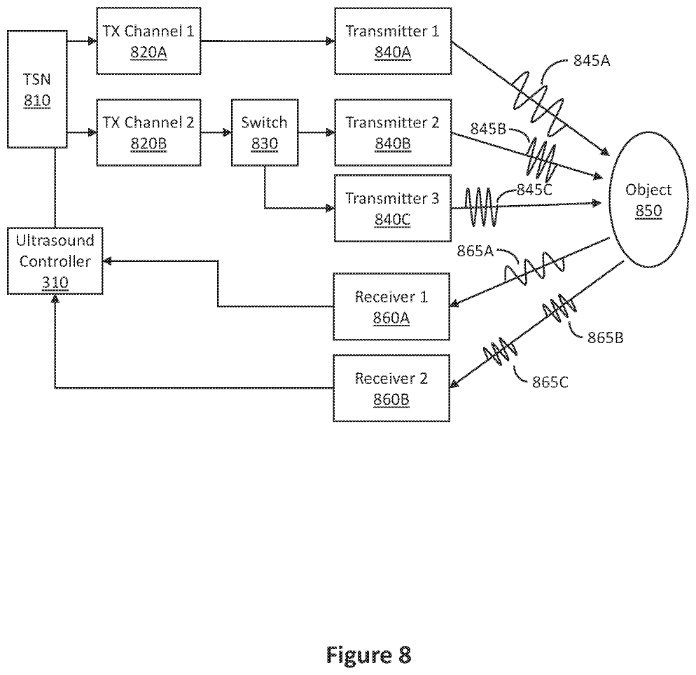

If their field of views overlap, the ultrasound systems 410a and 410c may use different frequencies, so that ultrasound waves originating from the ultrasound system 410a may be distinguished from ultrasound waves originating from the ultrasound system 410c. More generally, in some embodiments, a frequency or frequencies used by each ultrasound system 410 or 420 may be selected to avoid interference with other ultrasound transmitters, including other transmitters on the AV 110 and other devices transmitting ultrasound waves, e.g., other vehicles in the environment of the AV 110. For example, if the ultrasound controller 310 detects interference at a particular frequency, the ultrasound controller 310 may instruct the TX channel 320 to generate a waveform at a different frequency. In another embodiment, an ultrasound system may be configured to emit multiple waveforms with different frequencies (e.g., as described with respect to FIGS. 7 and 8), and in many or most cases, at least one of the frequencies may provide a reflected wave without interference from another vehicle or other device.

### Example Ultrasound System with TX Channel Generating and Receiving Waves

FIG. 5 is a block diagram illustrating an example ultrasound system 500 generating a wave and receiving a reflection, according to some embodiments of the present disclosure. The ultrasound system 500 is an example of the ultrasound system 240 of FIGS. 2 and 3. The ultrasound system 500 shown in FIG. 5 may be one implementation of the ultrasound systems 410 shown in FIG. 4.

The ultrasound system 500 includes the ultrasound controller 310, TX channel 320, and transmitter 330 described above. The transmitter 330 outputs an ultrasonic wave 555, which reflects off the object 560 to produce the reflection 565. The reflection 565 is sensed by the receiver 340, which converts the reflected ultrasonic wave into an electrical signal and transmits the electrical signal to the ultrasound controller 310.

FIG. 5 includes an example set of components in the TX channel 320. In this example, the TX channel 320 includes a TX receiver 510, a TX processing unit 520, a power amplifier 530, an analog filter 540, and a transformer 550. The components 510-550 are coupled in series, with an additional connection between the TX processing unit 520 and the analog filter 540 in some cases.

The TX receiver 510 is a receiving component of the TX channel 320 for receiving instructions from the ultrasound controller 310. The TX receiver 510 may be a high-speed differential signal transceiver. As described with respect to FIG. 3, the ultrasound controller 310 provides instructions to generate an electrical waveform, e.g., data specifying characteristics of a desired waveform. The TX receiver 510 may parse and/or reformat the instructions for the TX processing unit 520. The TX receiver 510 may provide feedback to the ultrasound controller 310, e.g., confirmation that the instructions were received and/or that the TX processing unit 520 was instructed accordingly.

The TX processing unit 520 receives waveform instructions from the TX receiver 510 and constructs a physical waveform signal based on the waveform instructions. The TX processing unit 520 may generate component signals at a frequency or frequencies higher than the frequency of the desired ultrasound waveform signal. These component signals may be combined to form the waveform signal with lower frequency than the component signals. For example, the TX processing unit 520 may have a fundamental frequency that is multiple times the frequency of the desired ultrasound wave, e.g., at least 10 times, at least 50 times, at least 100 times, at least 200 times, etc. A high frequency TX processing unit 520 can generate a wide variety of ultrasound waves by generating and combining component signals, e.g., the TX processing unit 520 may generate multiple ultrasound waveform signals that have different frequencies and/or shapes from each other.

The TX processing unit 520 may create a waveform signal using small steps. The high frequency of the TX processing unit 520 corresponds to relatively small intervals in the time domain, compared to the desired ultrasound frequency. Working at these relatively small time intervals, the TX processing unit 520 can produce, for example, an output signal having a single low frequency, an output signal with multiple discrete separate low frequencies, or a spectrum of low frequencies with adjustable amplitude. The output signal from the TX processing unit 520 may be in the direct shape of the desired ultrasound waveform, or the output signal may be in a modulated format. The TX processing unit 520 can be implemented as a microcontroller, a processor, a programmable logic device (PLD), an application specific integrated circuit (ASIC), or a discrete circuit.

In this example, the output of the TX processing unit 520 is coupled to an input of the power amplifier 530. The power amplifier 530 amplifies the signal from the TX processing unit 520, e.g., if the TX processing unit 520 generates the waveform signal with a relatively low amplitude. The power amplifier 530 outputs an amplified waveform signal, also referred to as an amplified signal. The power amplifier 530 may include one or more fast switch circuits. The power supply for the power amplifier 530 (e.g., the power supply for one or more fast switch circuits) is at higher voltage than the TX processing unit 520. The voltage of the power supply may determine the maximum value of the waveform signal after amplification by the power amplifier 530. A fast switch circuit can include, for example, one or more field effect transistors (FETs), bipolar junction transistors (BJTs), insulated gate bipolar transistors (IGBTs), or other types of amplifying devices. The fast switch circuit(s) may operate at the same high frequency as the TX processing unit 520.

In this example, the output of the power amplifier 530 is coupled to an input of the analog filter 540. The analog filter 540 receives the amplified waveform signal from the power amplifier 530 and filters the amplified waveform signal to generate a filtered waveform signal, also referred to as a filtered signal. The analog filter 540 may further receive the waveform signal output by the TX processing unit 520, as indicated by the arrow connecting the TX processing unit 520 to the analog filter 540 in FIG. 5. The analog filter 540 may be implemented as a low pass filter or a band pass filter. The analog filter 540 may receive either the amplified waveform signal from power amplifier 530 (e.g., if the waveform signal from the TX processing unit 520 needs amplification) or the waveform signal from the TX processing unit 520 (e.g., if amplification was not needed), and the analog filter 540 removes distortions and/or noise in the received signal. The analog filter 540 may also convert the received signal into an analog waveform, if the waveform signal from the TX processing unit 520 is a digital signal. For example, the analog filter 540 may include a digital-to-analog converter (DAC) followed by a band pass filter or low pass filter.

In this example, the output of the analog filter 540 is coupled to an input of the transformer 550. The transformer 550 receives the filtered waveform signal from the analog filter 540 and further increases the voltage amplitude of the received signal. The transformer 550 retains the frequency contents and waveform shape of the received signal. Unlike the power amplifier 530, the transformer may not increase the power of the received signal. The output of the transformer 550 is the output of the TX channel 320, i.e., the excitation voltage waveform provided to the transmitter 330. In some cases, if the voltage amplitude after the power amplifier or the analog filter is high enough to excite the transmitter 330, the transformer 550 may be omitted.

The ultrasound system 500 shown in FIG. 5 includes one transmitter 330 and one receiver 340. In other embodiments, an ultrasound system may include two or more transmitters 330 and/or two or more receivers 340. In general, different arrangements of the components illustrated in FIG. 5 can generate numerous combinations of ultrasonic waveforms and patterns, including repetitions of the same waveforms or different waveforms, and waveforms emitted simultaneously or with a programmable delay. Various arrangements of the ultrasound system components can be used to build complex structures for ultrasound object detection efficiently and economically. Several example ultrasound systems with multiple transmitters and receivers are illustrated in FIGS. 6-8.

### Example Time Multiplexed Ultrasound System

In general, a time multiplexed system uses one TX transmit path to drive multiple ultrasonic transmitters. A switch may be employed to implement different modes. In some embodiments, the switch enables exciting the transmitters in series, once at a time. For example, if a TX channel 320 is coupled to three transmitters 330 referred to as transmitter A, transmitter B, and transmitter C, the switch can alternately couple the TX channel 320 to transmitter A, then transmitter B, then transmitter C, then transmitter A, etc. Multiple receivers may capture the reflected ultrasonic waves. If transmitters A, B, and C are at different positions on the AV 110 and pointing in the same direction (or approximately the same direction), the reflections from the multiple transmitter locations enable the ultrasound controller 310 or onboard computer 150 can use the reflections from the multiple transmitter locations to achieve better detection resolution than if a single transmitter and receiver is used, and to enable localization of the object in the three-dimensional environment based on trigonometric calculations.

In some embodiments, the switch alternatively or additionally allows the TX channel 320 to drive a group of transmitters simultaneously. One or more receivers can also be included to capture the reflected ultrasonic waves. For example, each transmitter may emit ultrasound waves in a different direction and/or the receivers may detect reflected signals from different directions. Coupling multiple transmitters to a single TX channel 320, and reusing the TX channel 320 for different transmitters, is more cost efficient than including a separate TX channel for each transmitter.

FIG. 6 is a block diagram illustrating an example ultrasound system generating a pair of time multiplexed waves and receiving their reflections, according to some embodiments of the present disclosure. In the particular example of FIG. 6, the ultrasound controller 310 is coupled to the input of a TX channel 320 (which has the same components illustrated in FIG. 5), and the output of the TX channel 320 (in particular, the output of the transformer 550) is coupled to a switch 610. The switch 610 is coupled to a pair of transmitters 620A and 620B and switches the output of the transformer 550 between the two transmitters 620A and 620B. The transmitters 620A and 620B are similar to the transmitter 330 described above. The transmitters 620A and 620B output a pair of ultrasonic waves 625A and 625B. The ultrasonic waves 625A and 625B have the same shape, frequency, and amplitude, but the ultrasonic waves 625A and 625B are emitted at different times. In this example, the ultrasonic wave 625A is emitted before the ultrasonic wave 625B. At a later time, the first transmitter 620A may output another ultrasonic wave (which may be the same as the previously emitted wave or different from the previously emitted wave), followed by the second transmitter 620B, etc.

The ultrasonic waves 625A and 625B each reflect off the object 640 as reflected waves 635A and 635B, also referred to as reflections 635A and 635B. In this example, two receivers 630A and 630B receive reflections 635A and 635B of the waves 625A and 625B, respectively. The receivers 630A and 630B are similar to the receiver 340 described above. The receivers 630 each transmit electrical signals describing the reflected waves 635 to the ultrasound controller 310. In other embodiments, a single receiver receives both reflections 635A and 635B.

### Example Ultrasound System with Physical Repetition

The physical repetition method uses multiple TX transmit paths (e.g., multiple TX channels 320) to drive multiple ultrasonic transmitters 330 individually. The transmitters 330 can be excited by the same or different voltage waveforms simultaneously to generate the same or different acoustic waveforms simultaneously. Different waveforms may have different frequency contents, and the ultrasound controller 310 or another upstream processor (e.g., the onboard computer) may distinguish the reflected waveforms by frequency domain analysis. Physical repetition enables fast detection speed since multiple patterns can be analyzed simultaneously. Physical repetition also provides improved detection for moving targets (e.g., relative to a single receiver/transmitter or relative to the time multiplexing method described above) by obtaining a snapshot of the object at a particular time using multiple waveforms.

FIG. 7 is a block diagram illustrating an example ultrasound system generating two different waveforms and receiving their reflections simultaneously, according to some embodiments of the present disclosure. In the example of FIG. 7, the ultrasound controller 310 is coupled to two TX channels 710A and 710B, each of which may be similar to the TX channel 320 (e.g., each may have the same components illustrated in FIG. 5). Each TX channel 710A and 710B is coupled to a respective transmitter 720A or 720B. The transmitters 720A and 720B are similar to the transmitter 330 described above. The transmitters 720A and 720B output a pair of ultrasonic waves 725A and 725B. In this example, the ultrasonic waves 725A and 725B are different from each other, e.g., the ultrasonic wave 725A has a lower frequency than the ultrasonic wave 725B. In other embodiments, the ultrasonic waves 725A and 725B may have a same shape, e.g., the same frequency as each other.

In this example, the ultrasonic waves 725A and 725B are emitted simultaneously. To provide synchronization of the transmit paths, a time sensitive network (TSN) 750 may couple the ultrasound controller 310 to each of the TX channels 710A and 710B. The TSN 750 may use a communication protocol that provides synchronization across components or devices, such EtherCAT (Ethernet for Control Automation Technology, standardized in IEC 61158), or real-time Ethernet. As another example, the TSN 750 may be an A²B (automotive audio bus).

The ultrasonic waves 725A and 725B each reflect off the object 740 as reflected waves 735A and 735B, also referred to as reflections 735A and 735B. In this example, two receivers 730A and 730B receive reflections 735A and 735B of the waves 725A and 725B, respectively. The receivers 730A and 730B are similar to the receiver 340 described above. The receivers 730 each transmit electrical signals describing the reflected waves 735 to the ultrasound controller 310. In other embodiments, a single receiver receives both reflections 735A and 735B.

### Example Ultrasound System with Time Multiplexing and Physical Repetition

An ultrasound system having a combination of the time multiplex and physical repetition features described above may provide detailed information of a field of view of the ultrasound system, including, e.g., the speed, distance, angle, shape, and/or size of one or more objects in the environment of the AV 110. The onboard computer 150 or another processing system may generate a real time image of the environment based on the collected ultrasound data.

FIG. 8 is a block diagram illustrating an example ultrasound system generating two time multiplexed waves of the same frequency and another separate wave with a different frequency and receiving their reflections, according to some embodiments of the present disclosure. FIG. 8 includes the ultrasound controller 310, which is coupled to two TX channels 820A and 820B via a TSN 810. The TX channels 820A and 820B are similar to the TX channel 320 described above, and the TSN 810 is similar to the TSN 750 of FIG. 7. The second TX channel 820B is coupled to a switch 830, which is similar to the switch 610 of FIG. 6.

The TX channel 820A is coupled to a first transmitter 840A, which emits an ultrasonic wave 845A. The switch 830 alternates the output of the TX channel 820B between the transmitter 840B and the transmitter 840C, which output time multiplexed waves 845B and 845C. The waves 845B and/or 845C from the second and/or third transmitters 840B and 840C may be emitted simultaneously with the wave 845A from the first transmitter 840A. Each of the ultrasonic waves 845A, 845B, and 845C are reflected off the object 850 as reflected waves 865A, 865B, and 865C, respectively. In this example, the reflection 865A is received at the receiver 860A, and the reflections 865B and 865C are both received at the receiver 860B, at different times based on when the original waves 845B and 845C were emitted. The ultrasonic waves 845A, 845B, and 845C may be transmitted at different times relative to each other, e.g., with delays that are adjustable and/or programmable by the ultrasound controller 310.

### Example Process for Object Detection Using an Ultrasonic System

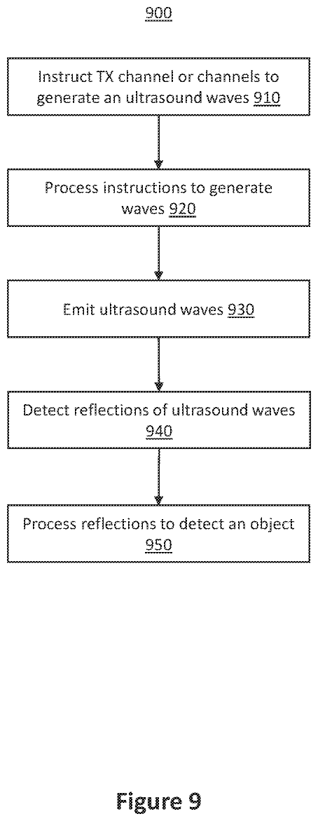

FIG. 9 is a flowchart illustrating a method for object detection using an ultrasonic system, according to some embodiments of the present disclosure. A controller (e.g., the ultrasound controller 310) instructs 910 one or more TX channels (e.g., one or more of the TX channels 320) to generate ultrasound waves. The instructions may include specifications for the wave or waves, such as shape, frequency, amplitude, etc. The controller may send instructions to one TX channel coupled to multiple transmitters (e.g., the TX channel 320 illustrated in FIG. 6, or the TX channel 820B illustrated in FIG. 8) and/or to multiple TX channels (e.g., to the TX channels 820A and 820B in FIG. 8, or the TX channels 710A and 710B illustrated in FIG. 7).

The TX channel or channels process 920 the instructions to generate the specified ultrasonic waves. For example, a TX processing unit 520 may generate electrical signals for the ultrasonic waves based on the instructions. The power amplifier 530, analog filter 540, and transformer 550 may further modify the electrical signals to generate the excitation voltage waveform for the ultrasonic wave.

One or more transmitters (e.g., one or more of the transmitters 330) emit 930 ultrasound waves based on the excitation voltage waveforms. In some examples, a single transmitter 330 emits multiple different waveforms (e.g., waveforms having different frequencies) at different times. In some examples, such as the examples shown in FIGS. 6-8, multiple transmitters output different waveforms at the same time and/or at different times.

One or more receivers (e.g., one or more of the receivers 340) detect 940 reflections of the ultrasound waves. As illustrated in FIGS. 5-8, the ultrasound waves reflect off of objects in the field of view of the ultrasound system, and the receivers 340 detect reflections of the waves. Different receivers 340 may detect reflections at different times, or different receivers 340 may select for certain signals, e.g., be tuned to a particular frequency. The receivers convert the ultrasound waves into electrical signals for further processing. The physical locations and distances of the transmitters (e.g., any of the transmitters in FIGS. 6-8) may be designed to obtain optimal signal enhancement and object detection.

A processor (e.g., the ultrasound controller 310 or the onboard computer 150) processes 950 the electrical signals encoding the reflected waves to detect an object in the field of view of the ultrasound system. For example, the processor may determine a distance to the object and/or other properties, such as a speed, size, and/or shape of the object.

### Select Examples

Example 1 provides a vehicle that includes a set of ultrasonic transmitters mounted to an exterior of a vehicle, the set of ultrasonic transmitters directed in a first direction and configured to output a set of ultrasonic waves; a set of ultrasonic receivers mounted to the exterior of the vehicle, the set of ultrasonic receivers configured to receive reflections of the set of ultrasonic waves and convert the received reflections into electrical signals; and a controller coupled to the ultrasonic transmitters and the ultrasonic receivers, the controller configured to instruct each of the set of ultrasonic transmitters to output a respective one of the set of ultrasonic waves; and detect an object based on the electrical signals from the set of ultrasonic receivers.

Example 2 provides the vehicle of example 1, further including a second set of ultrasonic transmitters mounted to the exterior of the vehicle, the second set of ultrasonic transmitters directed in a second direction different from the first direction, and the second set of ultrasonic transmitters configured to output a second set of ultrasonic waves; and a second set of ultrasonic receivers mounted to the exterior of the vehicle, the second set of ultrasonic receivers configured to receive reflections of the second set of ultrasonic waves.

Example 3 provides the vehicle of example 2, where the first direction is towards a front of the vehicle, and the second direction is towards a back of the vehicle.

Example 4 provides the vehicle of any of examples 1-3, further including a second controller, the second controller coupled to the second set of ultrasonic transmitters and the second set of ultrasonic receivers.

Example 5 provides the vehicle of any of examples 1-4, where the set of ultrasonic transmitters includes a first ultrasonic transmitter configured to transmit a first ultrasonic wave having a first frequency; and a second ultrasonic transmitter configured to transmit a second ultrasonic wave having a second frequency, the second frequency higher than the first frequency.

Example 6 provides the vehicle of example 5, where the set of ultrasonic receivers includes a first ultrasonic receiver configured to detect waves at the first frequency; and a second ultrasonic receiver configured to detect waves at the second frequency.

Example 7 provides the vehicle of any of examples 1-6, the set of ultrasonic transmitters including a first transmitter and a second transmitter, the vehicle further including a transmit channel coupled to the controller, the transmit channel configured to provide an excitation voltage for generating an ultrasonic wave based on instructions from the controller; and a switch coupled to an output of the transmit channel, an input of the first transmitter, and an input of the second transmitter, the switch configured to alternate the excitation voltage output from the transmit channel between the first transmitter and the second transmitter.

Example 8 provides the vehicle of example 7, where a receiver of the set of ultrasonic receivers is configured to receive reflections of the ultrasonic waves output by the first transmitter and the second transmitter.

Example 9 provides a system that includes a controller configured to output instructions for generating an ultrasonic waveform, the ultrasonic waveform having a first frequency; a transmit channel coupled to the controller, the transmit channel configured to output an excitation voltage for generating an ultrasonic wave based on the instructions from the controller, the transmit channel including a processing component for generating signals at a second frequency greater than the first frequency; an ultrasonic transmitter coupled to the transmit channel, the ultrasonic transmitter configured to produce an ultrasonic wave based on the excitation voltage; and a receiver configured to receive a reflection of the ultrasonic wave produced by the ultrasonic transmitter and to convert the received reflection into an electrical signal.

Example 10 provides the system of example 9, where the controller is coupled to a TSN, the transmit channel further including a receiving component configured to receive the instructions from the controller via the TSN.

Example 11 provides the system of example 10, where the ultrasonic wave is a first ultrasonic wave, the system further including a second transmit channel configured to receive second instructions from the controller via the TSN; and a second ultrasonic transmitter coupled to the second transmit channel, the second ultrasonic transmitter configured to produce a second ultrasonic wave, the second ultrasonic wave synchronized with the first ultrasonic wave.

Example 12 provides the system of any of examples 9-11, where the ultrasonic transmitter is a first ultrasonic transmitter, the system further including a second ultrasonic transmitter configured to produce a second ultrasonic wave; and a switch coupled to the transmit channel, the switch alternately coupling the transmit channel to the first ultrasonic transmitter or the second ultrasonic transmitter, where the first ultrasonic wave and the second ultrasonic wave are time multiplexed.

Example 13 provides the system of any of examples 9-12, where the second frequency is at least ten times the first frequency.

Example 14 provides the system of any of examples 9-13, where the transmit channel further includes a power amplifier circuit coupled to the processing component, the power amplifier configured to generate an amplified signal based on a constructed waveform received from the processing component; and a filter coupled to the power amplifier, the filter configured to reduce noise in the amplified signal to generate a filtered signal.

Example 15 provides the system of example 14, where the transmit channel further includes a transformer coupled to the filter, the transmit channel configured to increase a voltage amplitude of the filtered signal.

Example 16 provides the system of any of examples 9-15, where an ultrasonic transceiver includes the ultrasonic transmitter and the ultrasonic receiver.

Example 17 provides the system of any of examples 9-16, where the controller is configured to determine a distance to an object and a speed of the object based on the electrical signal.

Example 18 provides method for sensing an object, the method including transmitting a first ultrasonic wave; transmitting a second ultrasonic wave, the second ultrasonic wave having a different frequency from the first ultrasonic wave; receiving a first reflection of the first ultrasonic wave and a second reflection of the second ultrasonic wave; converting the first reflection and the second reflection into electrical signals; and detecting an object based on the electrical signals.

Example 19 provides the method of example 18, further including detecting interference in the first reflection; and determining the distance to the object based on an electrical signal representing the second reflection.

Example 20 provides the method of example 18 or 19, further including transmitting a third ultrasonic wave having a same frequency as the first ultrasonic wave, the third ultrasonic wave and the first ultrasonic wave transmitted at different times; receiving a third reflection of the third ultrasonic wave; converting the third reflection into an additional electrical signal; and determining the distance to the object further based on the additional electrical signal.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A vehicle comprising:
a set of ultrasonic transmitters mounted to an exterior of a vehicle, the set of ultrasonic transmitters directed in a first direction and configured to output a set of ultrasonic waves;
a set of ultrasonic receivers mounted to the exterior of the vehicle, the set of ultrasonic receivers configured to receive reflections of the set of ultrasonic waves and convert the received reflections into electrical signals; and
a controller coupled to the ultrasonic transmitters and the ultrasonic receivers, the controller configured to:
instruct each of the set of ultrasonic transmitters to output a respective one of the set of ultrasonic waves; and
detect an object based on the electrical signals from the set of ultrasonic receivers.

2. The vehicle of claim 1, further comprising:
a second set of ultrasonic transmitters mounted to the exterior of the vehicle, the second set of ultrasonic transmitters directed in a second direction different from the first direction, and the second set of ultrasonic transmitters configured to output a second set of ultrasonic waves; and
a second set of ultrasonic receivers mounted to the exterior of the vehicle, the second set of ultrasonic receivers configured to receive reflections of the second set of ultrasonic waves.

3. The vehicle of claim 2, wherein the first direction is towards a front of the vehicle, and the second direction is towards a back of the vehicle.

4. The vehicle of claim 1, further comprising a second controller, the second controller coupled to the second set of ultrasonic transmitters and the second set of ultrasonic receivers.

5. The vehicle of claim 1, wherein the set of ultrasonic transmitters comprises:
a first ultrasonic transmitter configured to transmit a first ultrasonic wave having a first frequency; and
a second ultrasonic transmitter configured to transmit a second ultrasonic wave having a second frequency, the second frequency higher than the first frequency.

6. The vehicle of claim 5, wherein the set of ultrasonic receivers comprises:
a first ultrasonic receiver configured to detect waves at the first frequency; and
a second ultrasonic receiver configured to detect waves at the second frequency.

7. The vehicle of claim 1, the set of ultrasonic transmitters comprising a first transmitter and a second transmitter, the vehicle further comprising:
a transmit channel coupled to the controller, the transmit channel configured to provide an excitation voltage for generating an ultrasonic wave based on instructions from the controller; and
a switch coupled to an output of the transmit channel, an input of the first transmitter, and an input of the second transmitter, the switch configured to alternate the excitation voltage output from the transmit channel between the first transmitter and the second transmitter.

8. The vehicle of claim 7, wherein a receiver of the set of ultrasonic receivers is configured to receive reflections of the ultrasonic waves output by the first transmitter and the second transmitter.

9. A system comprising:
a controller configured to output instructions for generating an ultrasonic waveform, the ultrasonic waveform having a first frequency;
a transmit channel coupled to the controller, the transmit channel configured to output an excitation voltage for generating an ultrasonic wave based on the instructions from the controller, the transmit channel comprising a processing component for generating signals at a second frequency greater than the first frequency;
an ultrasonic transmitter coupled to the transmit channel, the ultrasonic transmitter configured to produce an ultrasonic wave based on the excitation voltage; and
a receiver configured to receive a reflection of the ultrasonic wave produced by the ultrasonic transmitter and to convert the received reflection into an electrical signal.

10. The system of claim 9, wherein the controller is coupled to a time sensitive network (TSN), the transmit channel further comprising a receiving component configured to receive the instructions from the controller via the TSN.

11. The system of claim 10, wherein the ultrasonic wave is a first ultrasonic wave, the system further comprising:
a second transmit channel configured to receive second instructions from the controller via the TSN; and
a second ultrasonic transmitter coupled to the second transmit channel, the second ultrasonic transmitter configured to produce a second ultrasonic wave, the second ultrasonic wave synchronized with the first ultrasonic wave.

12. The system of claim 9, wherein the ultrasonic transmitter is a first ultrasonic transmitter, the system further comprising:
a second ultrasonic transmitter configured to produce a second ultrasonic wave; and
a switch coupled to the transmit channel, the switch alternately coupling the transmit channel to the first ultrasonic transmitter or the second ultrasonic transmitter, wherein the first ultrasonic wave and the second ultrasonic wave are time multiplexed.

13. The system of claim 9, wherein the second frequency is at least ten times the first frequency.

14. The system of claim 9, wherein the transmit channel further comprises:
a power amplifier circuit coupled to the processing component, the power amplifier configured to generate an amplified signal based on a constructed waveform received from the processing component; and
a filter coupled to the power amplifier, the filter configured to reduce noise in the amplified signal to generate a filtered signal.

15. The system of claim 14, wherein the transmit channel further comprises a transformer coupled to the filter, the transmit channel configured to increase a voltage amplitude of the filtered signal.

16. The system of claim 9, wherein an ultrasonic transceiver comprises the ultrasonic transmitter and the ultrasonic receiver.

17. The system of claim 9, wherein the controller is configured to determine a distance to an object and a speed of the object based on the electrical signal.

18. A method for sensing an object, the method comprising:
transmitting a first ultrasonic wave;
transmitting a second ultrasonic wave, the second ultrasonic wave having a different frequency from the first ultrasonic wave;
receiving a first reflection of the first ultrasonic wave and a second reflection of the second ultrasonic wave;
converting the first reflection and the second reflection into electrical signals; and
detecting an object based on the electrical signals.

19. The method of claim 18, further comprising:
detecting interference in the first reflection; and
determining the distance to the object based on an electrical signal representing the second reflection.

20. The method of claim 18, further comprising:
transmitting a third ultrasonic wave having a same frequency as the first ultrasonic wave, the third ultrasonic wave and the first ultrasonic wave transmitted at different times;
receiving a third reflection of the third ultrasonic wave;
converting the third reflection into an additional electrical signal; and
determining the distance to the object further based on the additional electrical signal.
